(19) United States
(12) Patent Application Publication
(10) Pub. No.: US 2005/0144221 A1
(43) Pub. Date: Jun. 30, 2005

(54) Picture downloading apparatus and method

(75) Inventors: Dong-Jae Shin, Seoul (KR); Yun-Hee Seok, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/915,100

(22) Filed: Aug. 10, 2004

(30) Foreign Application Priority Data
Dec. 8, 2003 (KR) 88652/2003

(51) Int. Cl. G06F 15/16

(52) U.S. Cl. 709/203

(57) ABSTRACT

An apparatus and method for downloading a picture from a picture server at the time of reviewing the picture in a mobile communication terminal. The mobile communication terminal receives at least one picture page of a first screen for a picture-review operating mode from the picture server and displays the received picture page. The mobile communication terminal determines whether a prefetch function has been set to download a preset number of picture pages. If the prefetch function has been set, the mobile communication terminal carries out a prefetch operation for downloading in advance, from the picture server, a next picture page that a user can view in a forward direction.

### PRIORITY

This application claims priority to an application entitled “PICTURE DOWNLOAD APPARATUS AND METHOD”, filed in the Korean Intellectual Property Office on Dec. 8, 2003 and assigned Serial No. 2003-88652, the contents of which are hereby incorporated by reference.

### BACKGROUND OF THE INVENTION

1. Field of the Invention

The present invention relates generally to a picture download apparatus and method, and more particularly to an apparatus and method for downloading a picture from a picture server while reviewing the picture in a mobile communication terminal.

2. Description of the Related Art

Currently, mobile communication terminals provide a number of user convenience functions other than a simple telephone function. Additionally, composite mobile phones, such as a camera phone, have been developed, thereby providing users with supplementary services using the camera phone.

Further, service providers are developing a next generation mobile phone, which will optimise efficiency of the mobile phone and maximize user convenience.

Among the composite mobile phones, the camera phone, in addition to common telephone functions, is able to take a picture, store the picture, and reproduce the stored picture. Accordingly, camera phones have become very popular.

Commonly, users of the camera phones take many pictures with their camera phones and upload these pictures from their camera phones to a web site including a camera-phone picture gallery. Although the camera phone has lower picture quality as compared with that of a digital camera, taking pictures with the camera phone is usually preferred by users because of the convenience and portability of the camera phone. For example, a user takes a picture, and can either send the picture to an opposite party, set the picture as a background picture or a picture ID (Identification), or access a picture server website and upload a captured picture to the picture server in order to properly manage the picture.

Additionally, a user has the option of storing the captured photos in a memory of the camera phone. However, there is a problem in that the memory of camera phone is limited and cannot always store as many pictures as the user wants due to the storage space limitations. Accordingly, in order to solve this problem, a number of methods have been developed for transferring the pictures stored with camera phone to a larger outside memory. For example, one method transmits captured pictures to a PC (Personal Computer) using a PC link. The pictures are then stored and managed in the PC. Another method, as described above, manages pictures at website using a picture management server (hereinafter, referred to as “picture server”).

FIG. 1 illustrates a network structure between a conventional mobile communication terminal and a picture server for managing pictures. It is assumed that the mobile communication terminal is a camera phone 100 in this specification. The camera phone 100 accesses a picture server 104 via a wireless network 102, and manages the pictures by making a picture album as well as a basic folder or inbox. Moreover, individual functions such as an erasing function, a copy function, a moving function, a sharing function, etc., can be performed. When the user selects a corresponding folder, inbox, or album to view a picture within the folder, inbox, or album, the camera phone 100 begins to download the picture of the album from the picture server 104 and display the downloaded picture on a screen of the camera phone 100.

FIG. 2 is a flow chart illustrating a process for accessing the picture server 104 using the conventional camera phone 100 and reviewing a picture. A user enters a picture review mode at step 200. At step 202, when the user selects a corresponding album folder, the camera phone 100 downloads a picture of the corresponding album folder from the picture server 104 and stores the downloaded picture in a memory at step 204. The downloaded picture is displayed at step 206, and at step 208, it is determined whether the user wants to view a new picture, rather than the currently displayed picture. At this point, the new picture can be a previous or next picture and the selection operation for viewing the new picture can be made through a specific key. The new picture at step 208 is a picture not currently stored in the memory, that is, a picture to be newly downloaded from the picture server 104.

When a new picture review mode is selected, new picture from the picture server 104 is downloaded and stored at step 214. At step 216, the downloaded picture is displayed on the screen of the camera phone 100.

When a new picture review mode is not selected at step 208, it determined if the user has entered a selection operation for viewing a picture stored in the memory at step 210. If a selection operation for viewing a picture stored in the memory has been made at step 210, the selected picture is read from the memory and immediately displayed on the screen at step 212.

However, if a selection operation for viewing a picture stored in the memory has not been made at step 210, the operation returns to step 208, where the user is again given the ability to select a new picture for review.

At step 218, if a key for terminating the picture review mode has been input, the process ends at step 220. Otherwise, the picture review mode is continuously performed, i.e., the process returns to step 208.

As illustrated in FIG. 2, a picture can be downloaded from the picture server 104 in the form of a thumbnail or expanded picture. Further, when a user accesses the picture server 104, downloads the picture, and views the downloaded picture, there is a first method for downloading a picture and a second method for storing a downloaded picture in the memory, which enables the user to view the stored picture later on. However, the first method imposes a time and cost burden on the user because the camera phone must access the picture server to download a picture whenever the user desires to view the picture. Therefore, there is preferred the second method in which the downloaded picture is stored in the memory and the stored picture is reviewed. The second method does reduce a time and cost burden on the user because the picture viewed once is stored in the internal memory of the terminal. However, in the method for storing the picture and employing the stored picture, downloading a new picture may be required. Therefore, when a new picture needs to be downloaded, there is a problem in that a corresponding picture page must be downloaded from the picture server 104 in the second method as in the first method.

For example, if the user's selection operation for viewing a new picture has been made on a current screen 300, as illustrated in FIG. 3, a standby time is needed for downloading a next screen, as indicated by reference numeral 302 in FIG. 3. That is, the user must wait until the next page is completely downloaded, because the next page begins to download only after the user's selection operation for viewing the new picture has been made.

As described above, if the selection operation for viewing the already downloaded picture stored in the memory has been made, the picture can be immediately displayed according to the conventional picture review method. However, when the user desires to view a new picture, i.e., one not currently stored in the memory of the picture phone, the user must wait until the download operation is completed successfully.

### SUMMARY OF THE INVENTION

Therefore, the present invention has been designed in view of the above and other problems, and it is an object of the present invention to provide an apparatus and method for rapidly downloading a picture from a picture server while reviewing the picture, without a substantial time delay in a mobile communication terminal.

In accordance with one aspect of the present invention, the above and other objects are accomplished by an apparatus for downloading a picture from a picture server to a mobile communication terminal, comprising: the mobile communication terminal for displaying at least one picture page received from the picture server on a screen, and for downloading in advance, from the picture server, a next picture page that a user can view in a forward direction by carrying out a prefetch operation according to a previously set prefetch function for downloading the at least one picture page; and the picture server for transmitting, to the mobile communication terminal, the at least one picture page requested by the mobile communication terminal.

In accordance with another aspect of the present invention, the above and other objects are accomplished by a method for downloading a picture from a picture server in a picture-review operating mode of a mobile communication terminal, comprising the steps of: receiving at least one picture page of a first screen for the picture-review operating mode from the picture server; displaying the received picture page; determining whether a prefetch function has been set to download a preset number of picture pages; and if the prefetch function has been set, carrying out a prefetch operation for downloading in advance, from the picture server, a next picture page to be viewed in a forward direction.

### BRIEF DESCRIPTION OF THE DRAWINGS

The above and other objects, features, and advantages of the present invention will be more clearly understood from the following detailed description taken in conjunction with the accompanying drawings, in which:

FIG. 1 illustrates a conventional network structure between a conventional mobile communication terminal and a picture server;

FIG. 2 is a flow chart illustrating a process for accessing a picture server and reviewing a picture using the conventional mobile communication terminal;

FIG. 3 illustrates picture pages displayed on a screen of the mobile communication terminal at the time of conventionally reviewing a picture;

FIG. 4 is a block diagram illustrating the internal structure of a mobile communication terminal in accordance with the present invention;

FIG. 5 is a flow chart illustrating a process for downloading a picture from a picture server using a prefetch function in the mobile communication terminal in accordance with a first embodiment of the present invention;

FIG. 6 illustrates pictures displayed on a screen of the mobile communication terminal at the time of reviewing a picture in accordance with the first embodiment of the present invention;

FIGS. 7A and 7B are flow charts illustrating a process for downloading a picture from the picture server using the prefetch function in the mobile communication terminal in accordance with a second embodiment of the present invention; and

FIGS. 8A and 8B show pictures displayed on the screen of the mobile communication terminal at the time of reviewing a picture in accordance with the second embodiment of the present invention.

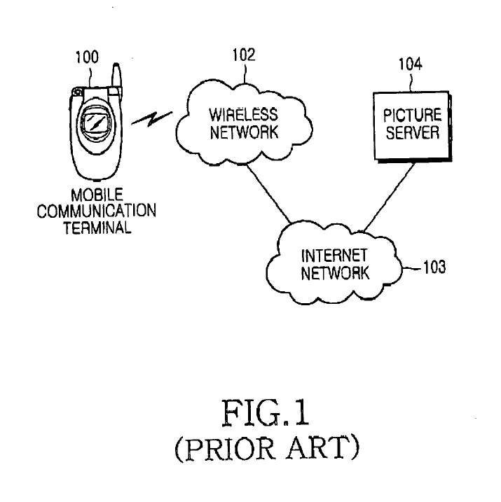

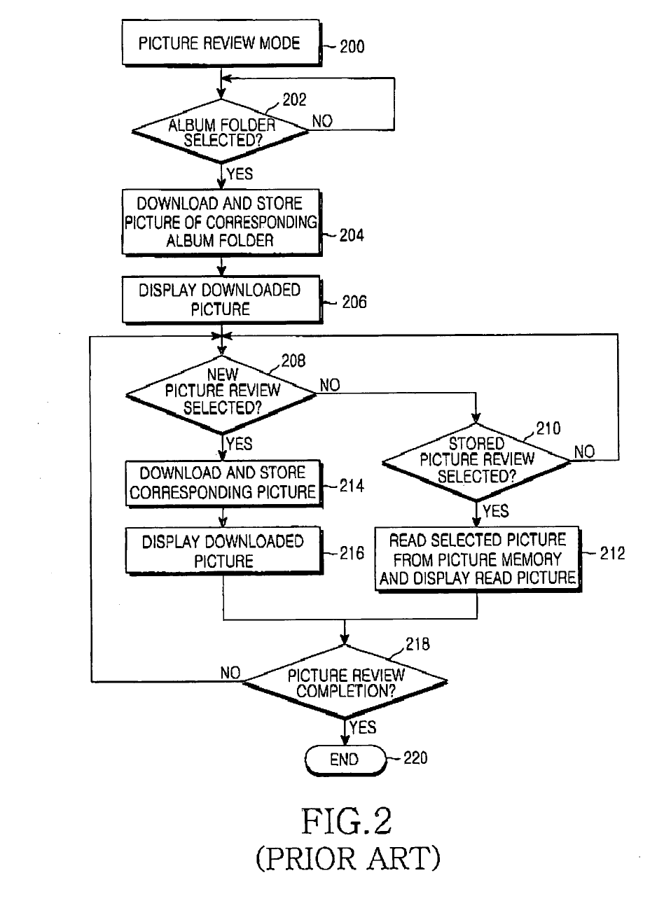

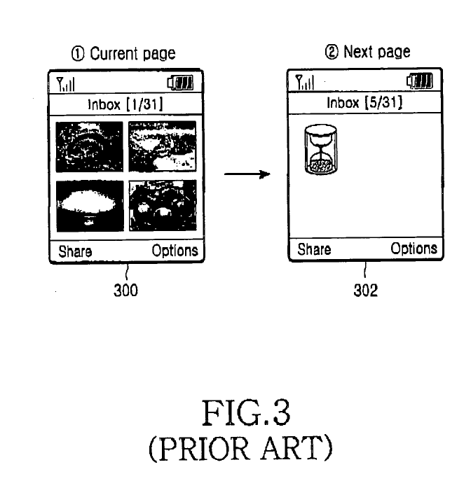

### DETAILED DESCRIPTION OF THE PREFERRED EMBODIMENTS

Preferred embodiments of the present invention will be described in detail herein below with reference to the annexed drawings. In the following description, a detailed description of known functions and configurations incorporated herein will be omitted when it may make the subject matter of the present invention rather unclear.

The present invention reduces time delay caused by a download operation for downloading a picture from a picture server 104 when a user wants to view a next picture a typical mobile communication terminal. In order to prevent this delay, the present invention provides a prefetch function. If the user sets the prefetch function, picture pages are downloaded from the picture server 104 by a preset number of picture pages in advance. Hereinafter, it is assumed that the mobile communication terminal is a camera phone in accordance with the embodiment of the present invention.

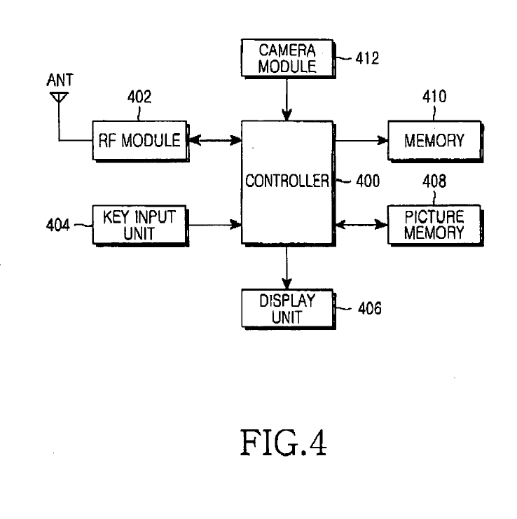

FIG. 4 is a block diagram illustrating the internal structure of the camera phone in accordance with the embodiment of the present invention. Referring to FIG. 4, the camera phone comprises a controller 400, an RF (Radio Frequency) module 402, a key input unit 404, a display unit 406, a picture memory 408, a memory 410, and a camera module 412. The controller 400 controls the overall operation of the camera phone and controls a download operation for a picture using the prefetch function in accordance with the present invention. Additionally, the controller 400 of the present invention controls the prefetch function, when a number of picture pages to be prefetched is preset by the user, at the time of downloading pictures. Moreover, the controller 400 downloads the preset number of the picture pages from the picture server and stores the downloaded picture pages in the picture memory 408, if the user has selected a picture review mode from a menu.

Herein, a picture page indicates a screen of the camera phone with one or more displayed pictures. That is, when, for example, four pictures are displayed on a single screen, the four pictures can form one picture page. Further, the user can preset the number of picture pages, page by page when the prefetch function is set in accordance with the present invention.

The RF module 402 communicates via a radio signal with a base station through an antenna ANT. The RF module 402 modulates a transmission signal input from the controller 400 and then transmits an RF signal based on the modulated signal through the antenna ANT. Moreover, the RF module 402 demodulates the RF signal received through the antenna ANT and sends the demodulated signal to the controller 400.

For example, the key input unit 404 comprises ten digit keys and a plurality of function keys including MENU, SEND or TALK, DELETE, END, *, # and volume keys. The key input unit 404 provides the controller 400 with key input data corresponding to a key pressed by the user.

Because the present invention is directed to a method for downloading a previously stored picture from a picture server, a processing configuration according to the camera's operation will be omitted.

The display unit 406 displays a current state of the terminal or a program progress state. For example, the display unit 406 can be implemented by an LCD (Liquid Crystal Display).

The picture memory 408 stores at least one picture downloaded from the picture server. The user can set a size of the picture memory 408 in accordance with the present invention. For example, the picture memory 408 is constituted by a ROM (Read Only Memory) storing various kinds of programs including a program storing control data required when the controller 400 performs a control operation, an NVM (Nonvolatile Memory) storing voice data, telephone numbers, personal names, etc., and a RAM (Random Access Memory) temporarily storing data generated when the program is controlled.

The camera module 412 converts an image picked up through a camera lens into a digital signal, captures a still picture from consecutive digital signals, and generates and outputs an image file.

Preferably, the camera phone uses HITP (Hypertext Transfer Protocol) for enabling an online connection to the picture server through a wireless network or an Internet network in order to communicate with the picture server. In this case, both a simple IP (Internet Protocol) and a mobile IP can be used.

Further, the picture server and the camera phone use a picture ID and an album ID. When pictures taken by the camera are uploaded to the picture server, the picture server assigns picture IDs to the uploaded pictures. When the user accesses the picture server and creates an album when managing the taken picture, an album ID is assigned. Accordingly, the pictures can be classified according to the picture and album IDs.

Additionally, the camera phone includes the picture memory 408 for storing the pictures.

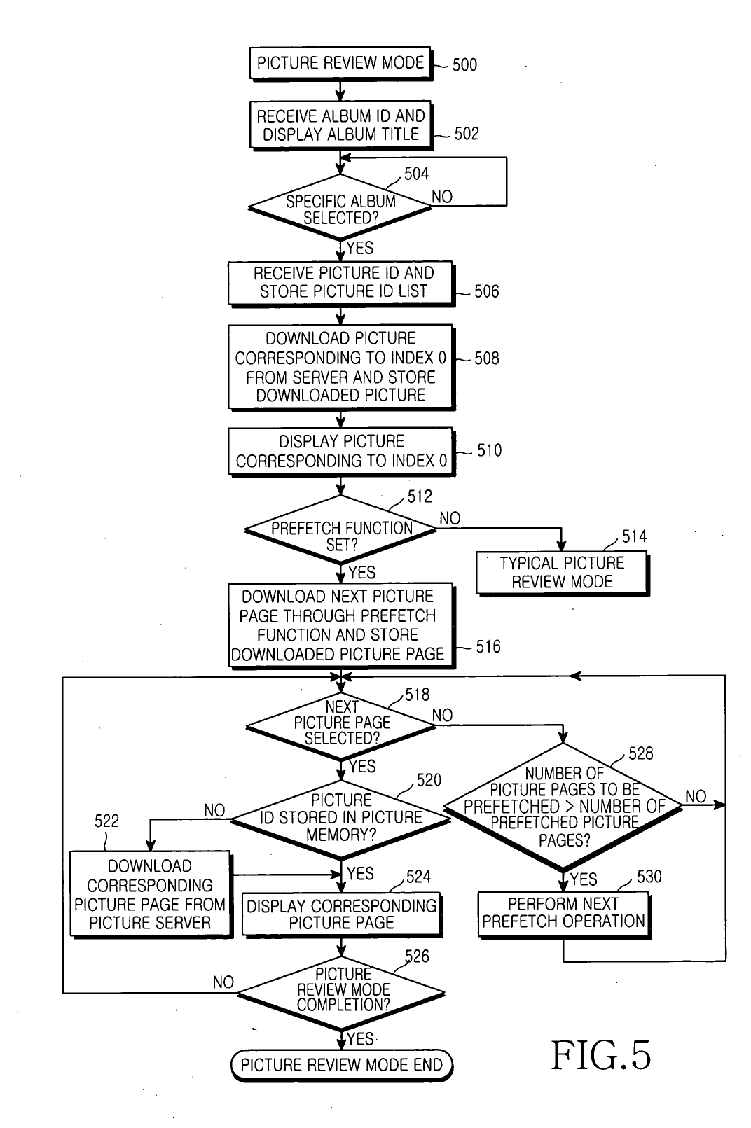

FIG. 5 is a flow chart illustrating a process for downloading pictures from the picture server using the prefetch function in the mobile communication terminal in accordance with a first embodiment of the present invention. When a picture is uploaded from the camera phone to the picture server, a specific picture ID is assigned to the picture by the picture server. In the method illustrated in FIG. 5, it is assumed that one screen (picture page) is preset to display only one picture. Furthermore, it is assumed that the camera phone in accordance with the present invention enters a picture review mode for viewing a picture, after accessing the picture server.

A camera phone enters a picture review mode at step 500, upon receiving a command from a user. At step 502, the camera phone accesses the picture server , and downloads at least one album ID from the picture server. Here, the number of album IDs corresponds to the number of albums created in the picture server. Then, the controller 400 displays an album title corresponding to each of the received album IDs.

At step 504, when the user selects a specific album, one or more picture IDs are received from the picture server and a list of picture IDs is stored at step 506.

At step 508, a picture corresponding to an index 0 of the picture ID list is downloaded from the picture server. Pieces of downloaded picture data are classified into a picture ID field, a picture index field and a picture data field, and the classified picture data pieces are stored in the picture memory 408.

At step 512, the controller 400 determines whether or not the prefetch function has been set. If the prefetch function has been set, the process proceeds to step 516. However, if the prefetch function has not been set, the process proceeds to step 514, where a typical picture review mode is performed. Herein, the typical picture review mode is an operating mode for starting to download a picture after the user's selection operation for viewing a new picture without using the prefetch function.

The present invention allows the preset number of pictures to be downloaded from the picture server. The user pays a fee for downloading desired pictures. Therefore, the present invention provides a menu item that enables the user to select the prefetch function in advance, such that the prefetch function can be performed according to the user's desire. The number of pictures to be prefetched must be preset by the user when the prefetch function is set. Further, the picture page in accordance with the present invention is a screen of the camera phone displaying at least one picture. That is, when four pictures are displayed on the screen of the camera phone, the four pictures form one picture page. When one picture is displayed on a single screen of the camera phone, the one picture forms one picture page.

If the prefetch function has been set, the controller 400 confirms the number of pictures to be downloaded, downloads the next picture page from the picture server using the prefetch function, and stores the downloaded picture page in the picture memory 408 at step 516. Therefore, if the user enters a command to view the next picture page at step 518, it is determined whether or not a corresponding picture ID has been stored in the picture memory 408 at step 520. If the picture ID has been stored in the picture memory 408, a corresponding picture page is displayed at step 524.

However, if the picture ID has not been stored in the picture memory 408, the corresponding picture page is downloaded from the picture server 104 and the downloaded picture page is stored in the picture memory 408 at step 522, and then displayed at step 524.

After the corresponding picture page has been successfully displayed, at step 526, the controller 400 determines whether a key for terminating the picture review mode has been input. If the key for terminating the picture review mode has been input, the process ends. However, if the key for terminating the picture review mode has not been input, the process returns to step 518.

If the user has scrolled the currently displayed picture page without selecting the next picture page at the above step 518, at the above step 528, the controller 400 determines whether the number of picture pages to be prefetched is larger than the number of prefetched picture pages. If the number of picture pages to be prefetched is larger than the number of prefetched picture pages, the next prefetch operation is performed at step 530 and then the process returns to step 518.

However, if the prefetch operation has been completely carried out for the preset number of picture pages, i.e., if the number of picture pages to be prefetched is larger than the number of prefetched picture pages at the above step 528, the process returns directly to step 518.

At step 518, the controller 400 is in a standby state until the user inputs a selection key for viewing the next picture page.

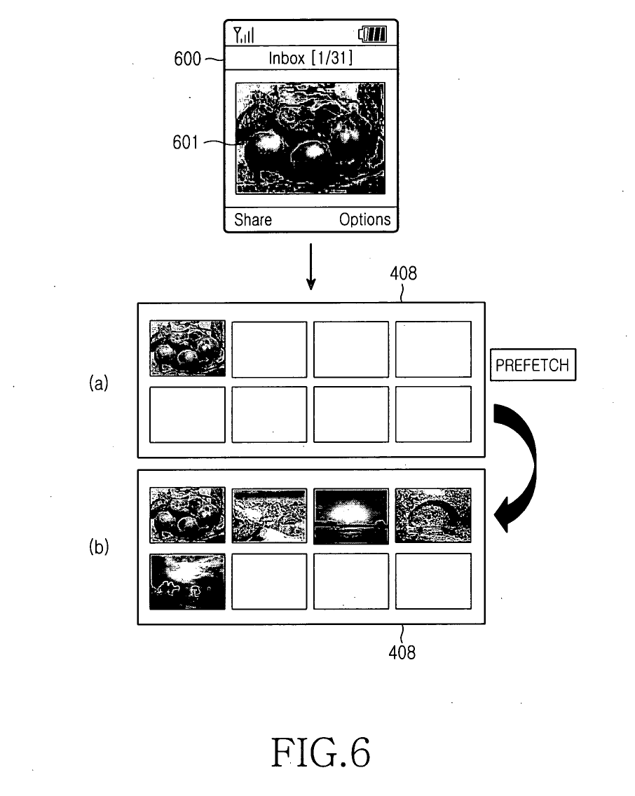

FIG. 6 illustrates pictures displayed on a screen of the camera phone while reviewing the pictures in accordance with the first embodiment of the present invention. Referring to FIG. 6, when the user selects a specific album, the controller 400 downloads the picture corresponding to an index 0 from the picture server 104 and then displays the downloaded picture indicated by reference numeral 601 in FIG. 6. Subsequently, the controller 400 stores the picture 601 in the picture memory 408 as indicated by (a) of FIG. 6. Further, the controller 400 downloads the preset number of picture pages from the picture server 104 and stores the downloaded picture pages as indicated by (b) of FIG. 6. In FIG. 6, the preset number of picture pages is 5 and a single screen is set to display one picture, i.e., five pictures are to be prefetched.

As described above, when a picture corresponding to an index 0 is first downloaded from the picture server 104, the controller 400 stores the downloaded picture in the picture memory 408 and displays the stored picture. Subsequently, the next picture is downloaded from the picture server 104 using the prefetch function and the downloaded picture is stored in the picture memory 408 while the user is scrolling the first picture page. When the user inputs a selection key for viewing the next picture, it is determined if there is present a picture ID corresponding to the next picture in the picture memory 408. If the picture ID is stored in the picture memory 408, the next picture is downloaded from the picture memory 408 and the downloaded picture is displayed. Otherwise, the controller 400 downloads the next picture from the picture server.

That is, the process for downloading the picture from the picture server to the camera phone using the prefetch function and the process for downloading the picture from the picture memory 408 to be displayed are independently carried out. The controller 400 communicates with the picture memory 408 to determine whether a desired picture is stored. If the desired picture is stored, the desired picture is read from the picture memory 408 and the read picture is displayed. However, if the desired picture is not stored, it is downloaded from the picture server.

When a picture to be displayed is not stored in the picture memory 408, a corresponding picture is newly downloaded using the prefetch function and the newly downloaded picture is stored in the picture memory 408. A function for allowing the user to set a size of the memory 408 is added to the camera phone, such that the user can select the number of pictures to be downloaded and stored through the prefetch function in advance.

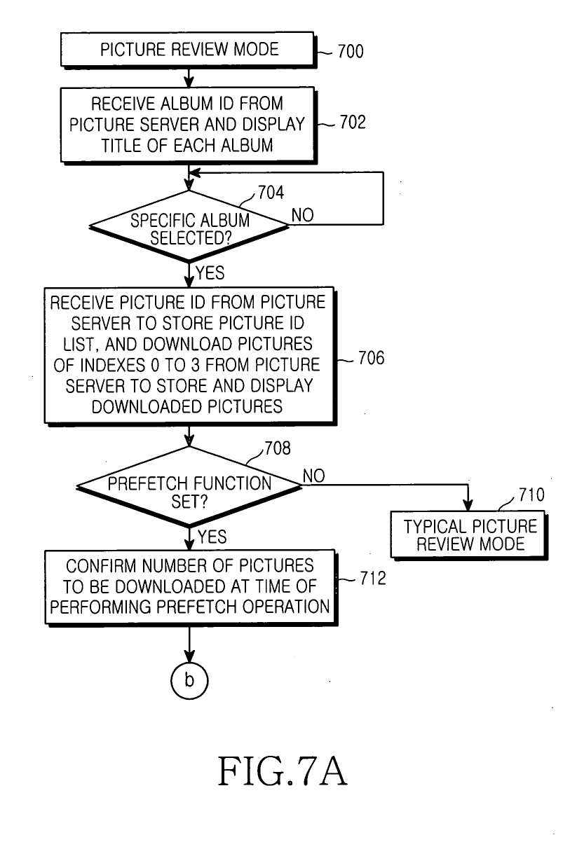

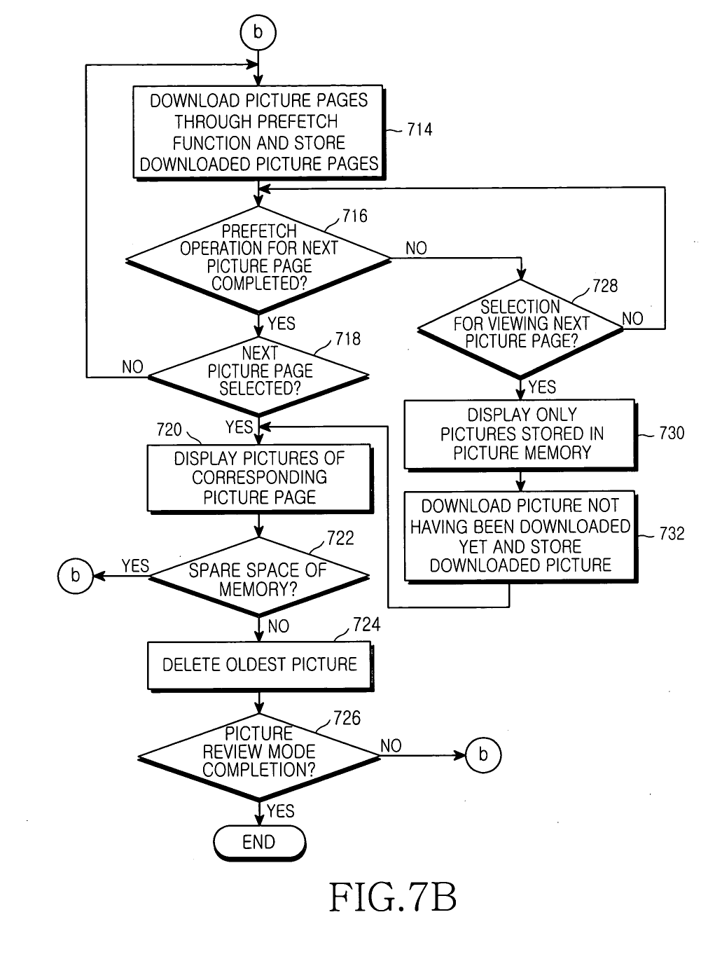

FIGS. 7A and 7B are flow charts illustrating a process for downloading at least one picture using the prefetch function from the picture server to the camera phone in accordance with a second embodiment of the present invention. In FIGS. 7A and 7B, it is assumed that the divided screen is a 4-way divided screen for displaying four pictures.

Referring to FIG. 7A, the controller 400 of the camera phone enters a picture review mode at step 700. At step 702, the camera phone accesses the picture server and then downloads album IDs from the picture server. The number of album IDs corresponds to the number of albums created in the picture server 104. Subsequently, the controller 400 displays an album title mapped to each of the received album IDs.

When the user has selected a specific album at step 704, at step 706, picture IDs are received from the picture server and a list of picture IDs is stored in the picture memory 408. Then, the pictures corresponding to picture indexes 0 to 3 of the picture ID list are downloaded from the picture server, respectively.

Pieces of downloaded picture data are classified into a picture ID, a picture index field and a picture data field, the classified picture data pieces are stored in the picture memory 408, and the received picture page is displayed on the screen.

At step 708, the controller 400 determines whether the prefetch function has been set. If the prefetch function has been set, the process proceeds to step 712. Otherwise, the process proceeds to step 710, where a typical picture review mode is carried out.

If the prefetch function has been set, the controller 400 confirms the number of pictures to be downloaded at step 712, and downloads the next picture page from the picture server 104 using the prefetch function to store the downloaded picture page at step 714 as illustrated in FIG. 7B.

At step 716, a determination is made as to whether the prefetch operation for the next picture page has been completed. When the user's selection operation for viewing the next picture page is made in a state when the prefetch operation for the next picture page has not been completed at step 728, only the pictures currently stored in the picture memory 408 are displayed at step 730. Subsequently, the picture or pictures that have not been downloaded yet, are downloaded from the picture server and stored at step 732. At this point, the prefetch operation for the next picture page currently being performed is paused, the undownloaded picture is downloaded from the picture server, and the downloaded picture is stored.

However, if the prefetch operation for the next picture page has been completed at the above step 716, at the above step 718, it is determined whether the selection operation for viewing the next picture page has been made. If the selection operation for viewing the next picture page has been made, the pictures of the corresponding picture page are displayed at step 720.

However, if the selection operation for viewing the next picture page has not been made at step 718, the process returns to step 714, such that the next picture page is downloaded through the prefetch operation and the downloaded picture page is stored. At step 716, the determination is then made as to whether the prefetch operation has been completed.

At step 722, it is determined whether a capacity of the picture memory 408 is sufficient for storing the pictures. If the capacity of the picture memory 408 is sufficient for storing the pictures, the process returns to step 714, such that the process for downloading the picture pages using the prefetch function and storing the downloaded picture pages can be carried out. However, if the capacity of the picture memory 408 is insufficient for storing the required pictures, the process proceeds to step 724.

At the above step 724, a first stored picture index is deleted. That is, the controller 400 produces an index of a picture to be deleted first. Because the pictures are sequentially stored according to picture indexes, the oldest picture having the largest index difference between the picture indexes of the pictures stored in the picture memory 408 is deleted from the picture memory 408.

Accordingly, at step 726, it is determined whether a key for terminating the picture review mode has been input. If the key for terminating the picture review mode has been input, the process ends. Otherwise, the process returns to step 714, such that the prefetch operation can be continuously performed.

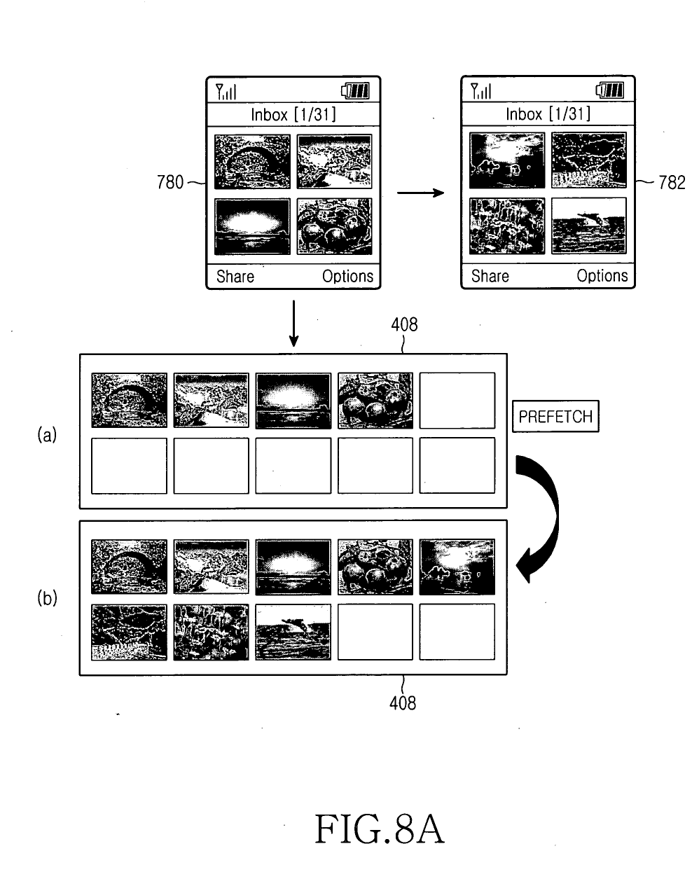

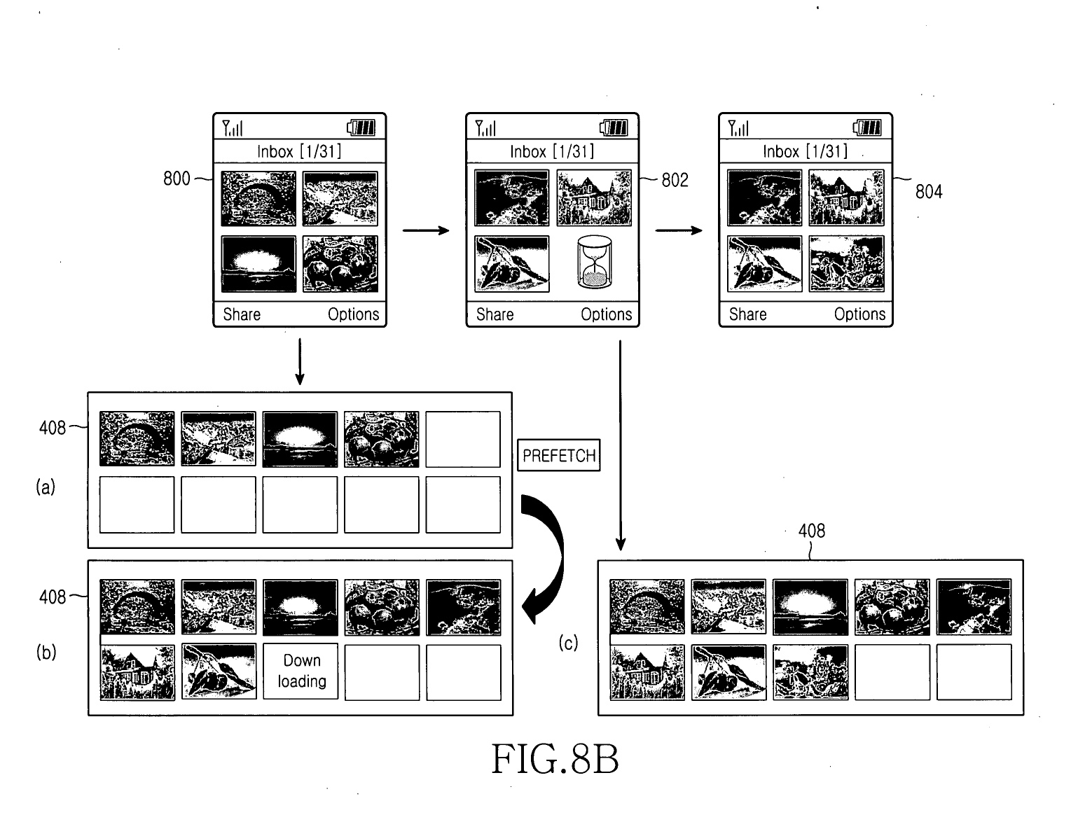

FIGS. 8A and 8B illustrate pictures displayed on a screen of the camera phone while reviewing the pictures in accordance with the second embodiment of the present invention. Referring to FIG. 8A, the controller 400 downloads four pictures corresponding to indexes 0 to 3 from the picture server when a specific album is selected by the user, and displays the downloaded pictures as indicated by reference numeral 780. The controller 400 stores the pictures indicated by reference numeral 780 in the picture memory 408 as illustrated in (a) of FIG. 8A. Further, the controller 400 downloads the next picture page from the picture server 104 using the prefetch operation for the next picture page to store the downloaded next picture page as illustrated in (b) of FIG. 8A. When the prefetch operation has been completed before the user's selection operation for viewing the next picture page is performed, the next picture page is read from the picture memory 408 and the read picture page can be displayed without time delay, as indicated by reference numeral 782.

However, when the prefetch operation for the next picture page has not been completed before the user's selection operation for viewing the next picture page is performed, the prefetch operation for the next picture page is paused. In this case, after only the pictures already stored in the picture memory 408 are displayed, the picture of the corresponding picture page that has not been downloaded yet from the picture server is downloaded and stored.

In FIG. 8B, only three of four pictures included in the next picture page have been successfully prefetched, i.e., one remaining picture has not been prefetched. Therefore, the three prefetched pictures are displayed as illustrated in screen 802 and information indicating that one remaining picture is being currently downloaded is displayed, according to the user's selection operation for viewing the next picture page. At this time, the controller 400 downloads the one remaining picture from the picture server as illustrated in (b) of FIG. 8B, stores the downloaded picture as illustrated in (c) of FIG. 8B, and displays all the downloaded pictures as shown in a screen 804, if the download process for all pictures of the next picture page has been completed.

When the 5^{th} to 8^{th} pictures are prefetched, the user may make a selection operation for viewing the next picture page while the 7^{th} picture is being downloaded, that is, before the 8^{th} picture is prefetched. In this case, after the 5^{th} to 7^{th} pictures are downloaded and stored in the picture memory 408, it is determined whether there are any picture IDs corresponding to the 5^{th} to 8^{th} pictures in the picture memory 408. The 5^{th} to 7^{th} pictures can be immediately displayed because the 5^{th} to 7^{th} pictures are stored in the picture memory 408, and the 8^{th} picture is downloaded while information indicating that the 8^{th} picture is being currently downloaded is displayed as shown in the screen 802.

As described above, if the prefetch function has been set in accordance with the present invention, it is determined whether the next picture in a forward direction is present in the picture memory 408 while the user is viewing one or more pictures on a current screen. When the next picture in the forward direction is present, the picture downloaded, in advance, from the picture server 104 can be immediately displayed on a screen of the terminal without time delay.

Although the preferred embodiments of the present invention have been disclosed for illustrative purposes, those skilled in the art will appreciate that various modifications, additions and substitutions are possible, without departing from the scope of the invention. For example, the process for reviewing pictures uploaded by the user using the terminal has been described in accordance with the embodiments of the present invention. Moreover, the present invention can also be applied to the case where the pictures not uploaded by the user are downloaded from the picture server and the downloaded pictures are reviewed. The camera phone downloading the pictures from the picture server has been described in accordance with the embodiments of the present invention. However, all mobile communication terminals can download the pictures from the picture server 104 using the embodiments of the present invention. Therefore, the present invention is not limited to the above-described embodiments, but the present invention is defined by the following claims, along with their full scope of equivalents.

1. An apparatus for downloading a picture, comprising:
a mobile communication terminal for displaying at least one picture page on a display thereof; and
a picture server for transmitting, to the mobile communication terminal, the at least one picture page requested by the mobile communication terminal;
wherein the mobile communication performs a prefetch operation in accordance with a prefetch function by downloading in advance, from the picture server, a next picture page that a user can view in a forward direction.

2. The apparatus according to claim 1, wherein the mobile communication terminal downloads and stores a preset number of picture pages from the picture server when the user has set the prefetch function.

3. The apparatus according to claim 1, wherein the picture page is configured on a single screen of the display and includes at least one picture downloaded from the picture server.

4. The apparatus according to claim 2, wherein the prefetch function downloads the preset number of picture pages from the picture server in response to a key input by the user for downloading a new picture.

5. The apparatus according to claim 1, wherein the mobile communication terminal comprises:
a picture memory for sequentially storing the at least one picture page downloaded from the picture server; and
a controller for downloading, in advance, a preset number of picture pages from the picture server and storing the downloaded picture pages in the picture memory, when the prefetch function has been set.

6. The apparatus according to claim 5, wherein the controller controls the number of picture pages to be downloaded in advance that is selected by the user using the prefetch function, and deletes pictures in a same order that the pictures are stored when a space of the picture memory is insufficient.

7. The apparatus according to claim 5, wherein the controller pauses the prefetch operation, if a key input for viewing the next picture page is made by the user while the next picture page is currently being prefetched from the picture server in a state where at least one picture is set to be displayed on one picture page.

8. The apparatus according to claim 7, wherein the controller displays information indicating that at least one picture having not been prefetched yet is currently being prefetched while continuing to download the at least one picture.

9. A method for downloading a picture from a picture server in a picture-review operating mode of a mobile communication terminal, comprising the steps of:
receiving at least one picture page of a first screen for the picture-review operating mode from the picture server;
displaying the received at least one picture page;
determining whether a prefetch function has been set to download a preset number of next picture pages; and
if the prefetch function has been set, carrying out a prefetch operation for downloading in advance, from the picture server, the preset number of next picture pages to be viewed in a forward direction.

10. The method according to claim 9, further comprising the steps of:
determining whether a selected picture page has been stored in a picture memory if a user selection is made for viewing one of the next picture pages and displaying the one of the next picture pages on a screen, if it has been stored; and
if the one the next picture pages has not been stored in the picture memory, pausing the prefetch operation, and downloading the one of the next picture pages from the picture server to display the downloaded picture page on the screen.

11. The method according to claim 9, wherein the step of carrying out the prefetch operation for downloading, in advance, the preset number of next picture pages to be viewed in the forward direction from the picture server comprises:
downloading the present number of picture pages preset by a user from the picture server; and
storing the downloaded picture pages in a picture memory.

12. The method according to claim 11, further comprising the step of:
deleting pictures in a same order that the pictures are stored when a capacity of the picture memory is insufficient for storing the picture pages downloaded from the picture server.

13. The method according to claim 9, further comprising the steps of:
if a key input for viewing a next picture page is made by the user before the prefetch operation for the next picture page to be viewed in the forward direction has been completed, pausing the prefetch operation for pictures from the picture server and displaying only at least one prefetched picture; and
downloading, storing, and displaying at least one picture that has not been prefetched yet.

14. The method according to claim 13, wherein the step of displaying only the at least one prefetched picture comprises displaying information indicating that the at least one picture having not been prefetched yet is being downloaded together with the at least one prefetched picture.
